(19) United States
(12) Patent Application Publication
(10) Pub. No.: US 2007/0111155 A1
(43) Pub. Date: May 17, 2007

(54) Dental articulator systems and methods

(76) Inventor: Kamil Karroum, Lawrenceville, GA (US)

Correspondence Address: CANTOR COLBURN, LLP, 55 GRIFFIN ROAD SOUTH, BLOOMFIELD, CT, 06002, US

(21) Appl. No.: 11/599,716

(22) Filed: Nov. 14, 2006

Related U.S. Application Data
(60) Provisional application No. 60/736,530, filed on Nov. 14, 2005.

(51) Int. Cl. A61C 11/00

(52) U.S. Cl. 433/60

(57) ABSTRACT

Dental articulator systems and methods. Exemplary embodiments include an articulator apparatus, including a base having an upper surface, a first outer row of pins arranged along a portion of the base, a second inner row of pins arranged along another portion of the base adjacent the first outer row of pins and an inner platform located on the base adjacent the second inner row of pins.

Priority based on U.S. Provisional Patent Application Ser. No. 60/736,530, filed on Nov. 14, 2005, and entitled, “Dental Articulator Systems”, is claimed.

### BACKGROUND

I. Field of the Invention

The present invention relates generally to the field dentistry and, more particularly to dental articulator systems and methods.

II. Description of the Related Art

Often times in dentistry, it becomes necessary for a dentist to fit a patient with a crown, bridge or even dentures. The tooth or teeth (collectively called teeth) are prepped, generally by taking an impression of the teeth of interest by pouring a molding material around the teeth and allowing it to harden. The mold is removed and sent to a lab in order to make a model of the teeth in preparation to create the crown, bridge denture and the like. Stone is poured into the impression so that, when hardened, a model of the teeth is created. Typically, a top and bottom jaw model is created. One use of the model is for use in an articulator, in which the model is fitted, so that the top and bottom pieces can be placed to simulate the actual bite of the patient. Therefore, during the pouring of the stone into the impression several additional steps are required such as adding pins into the wet stone for subsequent additional stone placement, which is subsequently affixed to an articulator base. The articulator base is typically proprietary for use with specific bases. As such, there exists no standard interface base that can be used with any articulator. More importantly, alignment jigs are used to align the jaws of an articulator. Such alignment jigs are non-standard and specific to proprietary articulators, which can be very costly. In addition, articulator joints must typically be added and connected to the stone.

### SUMMARY

In general, the invention features dental articulator systems and methods.

In general, in one aspect, the invention features an articulator apparatus, including a base having an upper surface, a first outer row of pins arranged along a portion of the base, a second inner row of pins arranged along another portion of the base adjacent the first outer row of pins and an inner platform located on the base adjacent the second inner row of pins.

In one implementation, the individual pins of the rows of pins are perpendicular to the upper surface.

In another implementation, the individual pins of the first outer row of pins have a height H.

In another implementation, individual pins of the second inner row of pins have a height h.

In another implementation, H is greater than h.

In another implementation, the inner platform is positioned above the upper surface thereby forming a perimeter wall around the platform.

In another implementation, the perimeter wall is adjacent the second inner row of pins

In still another implementation, the perimeter wall comprises a series of ridges adjacent the inner row of pins.

In yet another implementation, the apparatus further includes a half-hinge connected to a rear end of the base.

In another aspect, the invention features a dental articulator calibration system, including an elongate central body having an upper plate-receiving opening and a lower plate-receiving opening, an upper plate having a mating surface for mating with the upper plate-receiving opening and an articulator surface, a lower plate having a mating surface for mating with the lower plate-receiving opening and an articulator surface, a first articulator-specific base plate connected to the upper plate and a second articulator-specific base plate connected to the lower plate.

In one implementation, the first articulator-specific base plate is connected to the articulator surface of the upper plate and the second articulator-specific base plate connected to articulator surface of the lower plate.

In another implementation, the mating surfaces of the upper and lower mating plates are for interconnection with a dental model plate.

In another aspect, the invention features an articulator alignment kit, including a central alignment jig-blank, a first alignment plate for positioning on one end of the jig-blank, a second alignment plate for positioning on an opposite end of the jig-blank and an articulator-specific base plate connected to each of the first and second alignment plates, each articulator-specific base plate for connection to a respective upper and lower jaw of an articulator.

In still another aspect, the invention features a method for aligning an articulator having an upper and lower jaw, including placing an alignment jig-blank between the upper and lower jaws, connecting an upper alignment plate combination on the upper jaw of the articulator, connecting a lower alignment plate combination on the lower jaw of the articulator, placing the upper and lower alignment plate combinations in contact with the alignment jig-blank and performing adjustments on the articulator jaws thereby aligning the articulator.

In one implementation, the upper alignment plate combination on the upper jaw of the articulator and the lower alignment plate combination on the lower jaw of the articulator each comprise a base alignment plate connected to an articulator-specific base plate.

In yet another aspect, the invention features a method of aligning a dental articulator, including pre-fitting an first proprietary mounting base to a first generic mounting base, pre-fitting an second proprietary mounting base to a second generic mounting base, connecting the first proprietary mounting base to a first generic mounting base combination to an upper jaw of an articulator, connecting the second proprietary mounting base to a second generic mounting base combination to a lower jaw of an articulator, placing an articulator alignment jig-blank between jaws of an articulator, placing the two combinations in contact with the articulator jig-blank and making alignment adjustments to the articulator jaws to accommodate the articulator jig-blank for subsequent affixation of a dental model between the jaws.

In another aspect, the invention features a dental articulator apparatus, including a main articulator body, an upper jaw connected to the body, a lower jaw connected to the body and in opposition to the upper jaw, an upper proprietary mounting base connected to the upper jaw and an upper generic mounting base connected to the upper proprietary mounting base and a lower proprietary mounting base connected to the lower jaw and a lower generic mounting base connected to the lower articulator specific base;

In another aspect, the invention features a dental articulator system, including a dental articulator having an upper and lower jaw, an articulator base connected to each of the upper and lower jaws, an additional articulator base connected to each of the upper and lower articulator bases, wherein the upper articulator bases and the lower articulator bases are a first upper and lower articulator base combination, a articulator alignment jig-blank for connecting between the additional articulator bases and a dental model having an upper and lower jaw, wherein each of the upper and lower jaws each include a second upper and lower articulator base combination for connection to the upper and lower jaws of the articulator, the dental model having a bite pattern of a patient.

In one implementation, the jig-blank is for alignment of the articulator by placement in between the first upper and lower articulator combinations.

In another implementation, the first upper and lower base combinations are removable from the upper and lower jaws of the articulator.

In another implementation, the second upper and lower articulator combinations are connectable to the upper and lower jaws of the articulator to form a bite pattern matching the bite pattern of the patient.

One advantage of the invention is that the articulator apparatuses remove several model formation steps in creating dental models.

Another advantage of the invention is that the apparatuses retain the bite pattern of patient impressions.

Another advantage of the invention is that less stone is used in making dental models.

Another advantage of the invention is that articulator alignment can be made generic to a generic alignment jig.

Another advantage of the invention is that generic mounting bases can be interfaced to proprietary bases to create a generic mounting interface for any articulator.

Another advantage of the invention is that the apparatuses can be generically mounted to any articulator using the generic interface.

Other objects, advantages and capabilities of the invention are apparent from the following description taken in conjunction with the accompanying drawings showing the preferred embodiment of the invention.

### BRIEF DESCRIPTION OF THE DRAWINGS

FIG. 1A illustrates a bottom perspective view of an exemplary embodiment of a dental articulator base;

FIG. 1B illustrates a top perspective view of an exemplary embodiment of a dental articulator base;

FIG. 2A illustrates a top perspective view of another exemplary embodiment of a dental articulator base;

FIG. 2B illustrates a bottom perspective view of another exemplary embodiment of a dental articulator base;

FIG. 3A illustrates a top perspective view of an exemplary embodiment of a dental articulator mounting plate;

FIG. 3B illustrates a bottom perspective view of an exemplary embodiment of a dental articulator mounting plate; and

FIG. 4 illustrates a perspective view of an exemplary articulator calibration jig.

### DETAILED DESCRIPTION

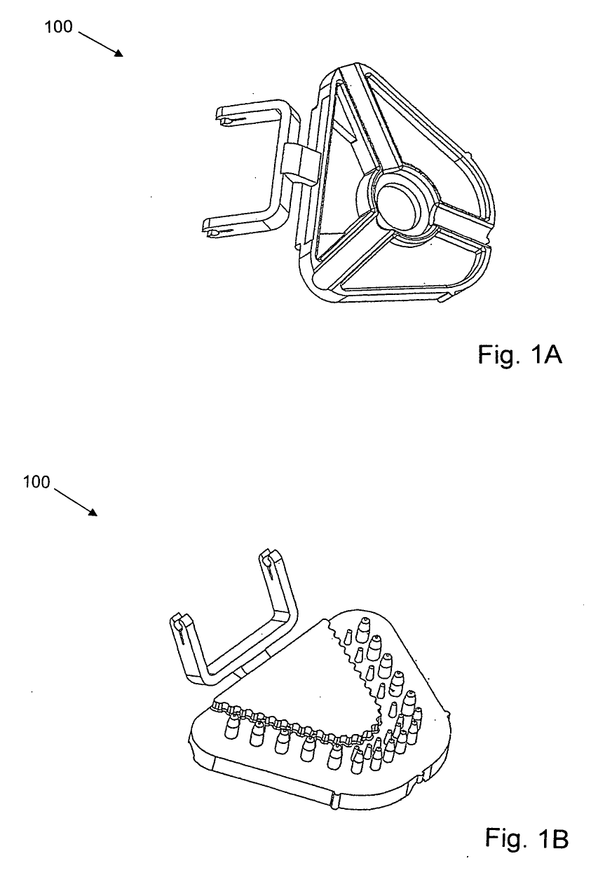

Referring to the drawings wherein like reference numerals designate corresponding parts throughout the several figures, reference is made to FIGS. 1-4 that illustrate several view of several embodiments if articulator systems.

### Articulator Apparatuses

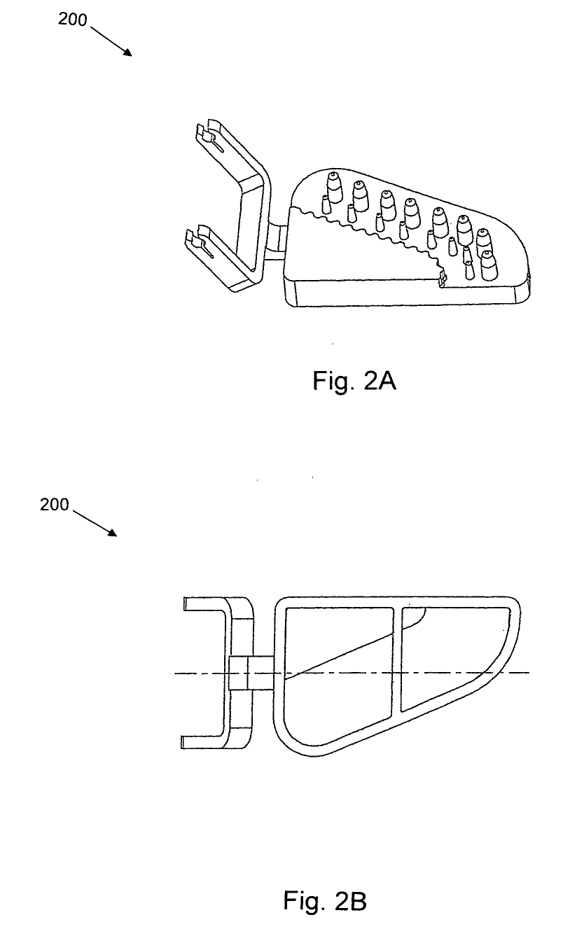

FIG. 1A illustrates a bottom perspective view of an exemplary embodiment of a dental articulator base 100. FIG. 1B illustrates a top perspective view of an exemplary embodiment of a dental articulator base 100. FIG. 2A illustrates a top perspective view of another exemplary embodiment of a dental articulator base 200. FIG. 2B illustrates a bottom perspective view of another exemplary embodiment of a dental articulator base 200.

In general, several embodiments of articulator apparatuses are described. It is appreciated that the apparatuses generally include an upper and lower jaw model base connected together in opposition by an integral hinge pair. The integral hinge provides immediate alignment of the model because the stone is poured directly onto the upper and lower model bases when the impression is modeled. It is further appreciated that the articulators described herein can include upper and lower half-bases when it is desired to have models created from impression that have been taken on only one side of the patient's mouth.

In one embodiment, an articulator apparatus can generally include a base having an upper surface, a first outer row of pins arranged along a portion of the base, a second inner row of pins arranged along another portion of the base adjacent the first outer row of pins; and an inner platform located on the base adjacent the second inner row of pins. In general, an additional base is contemplated in opposition to the base described.

Typically, the individual pins of the rows of pins are perpendicular to the upper surface of the base and the individual pins of the first outer row of pins have a height H. Furthermore, the individual pins of the second inner row of pins have a height h. Typically, the height H is greater than height h. The inner platform is typically positioned above the upper surface thereby forming a perimeter wall around the platform, the perimeter wall being adjacent the second inner row of pins. It is desirable for the perimeter wall to include a series of ridges adjacent the inner row of pins.

As mentioned above, the apparatus typically includes opposing, or upper and lower bases that are connected together by respective half-hinges connected to a rear end of each base.

As mentioned above, model stone is poured directly onto each respective base and the impression is placed directly onto the stone. Therefore, the stone dries directly onto the rows of pins and to the ridges. By the impression being directly modeled onto the articulator bases, the exact bite is therefore formed because the hinges close onto the impression as the stone dries to create the model. When the stone dries, the impression is removed and the resulting bite of the model is the same as the bite of the impression as taken by from the patient. The stone can be removed from the base (generally silicone spray or other suitable lubricant cab be added prior to adding the stone to allow ease of removal.) The portion of the stone that is in contact with the articulator bases now includes impressions from the rows of the pins and the ridges. The combination of the pins and the ridges and the resulting impressions from the pins and ridges prevents virtually all unwanted movement of the model on the articulator, and further provides exact replacement of the model to the articulator when the model is removed and cut, sanded and otherwise modified when taking the necessary steps to create the dental crown denture and the like. For example, if a crown is to be created, the tooth of interest on the model can be isolated by cutting it from the rest of the model. That particular tooth model includes respective hole and ridge impressions from the articulator. Therefore, regardless of how that tooth model is cut, it can be placed back into its precise location on the articulator where it is removed and it retains its true bite pattern with respect to the other model portions, upper and lower. This retaining of the bite pattern is possible because in general, the two rows of pins prevent side to side rotational and lateral movement. The ridges prevent sliding from side to side and rotational movement. In general, it is appreciated that the pins and the ridges prevent virtually all freedoms of motion of the model and model portions. It is further appreciated that the pins are tapered from top to bottom to allow both ease of removal and insertion of the model onto the articulator as well as a snug fit by the taper being largest closest to the surface of the base.

In general, the bases can include a series of support patterns to prevent warping and bending of the bases during use and to generally increase the overall strength of the base. In another implementation, the surface of the base opposite the model surface can include a depression to receive a coupling device such as a magnet to couple to an additional base for use with other articulators as described further below.

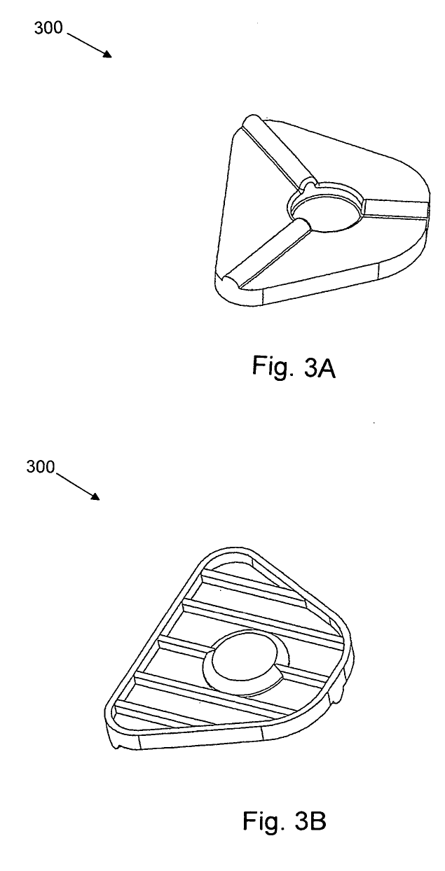

FIG. 3A illustrates a top perspective view of an exemplary embodiment of a dental articulator mounting plate 300. FIG. 3B illustrates a bottom perspective view of an exemplary embodiment of a dental articulator mounting plate 300.

### Dental Articulator Calibration Systems

In general, a dental articulator calibration system can be advantageous to provide a standard for calibration of all proprietary articulators without the need to purchase individual expensive alignment/calibration jigs for each individual proprietary articulator.

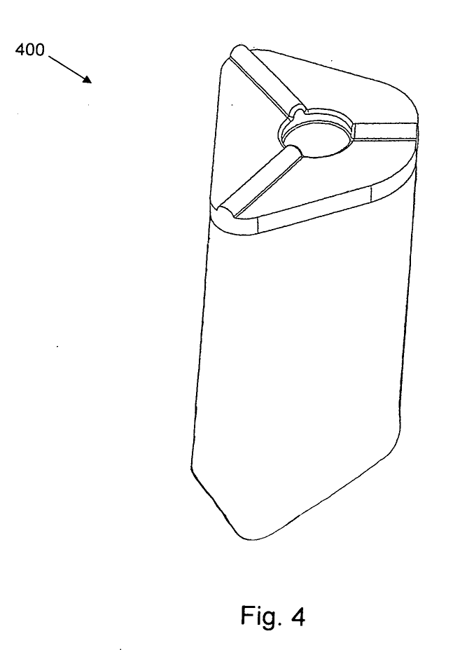

FIG. 4 illustrates a perspective view of an exemplary articulator calibration jig 400.

In one embodiment, the system can include an elongate central body having an upper plate-receiving opening and a lower plate-receiving opening, an upper plate having a mating surface for mating with the upper plate-receiving opening and a articulator surface, a lower plate having a mating surface for mating with the lower plate-receiving opening and an articulator surface, a first articulator-specific base plate connected to the upper plate and a second articulator-specific base plate connected to the lower plate.

In a typical implementation, the first articulator-specific base plate is connected to the articulator surface of the upper plate and the second articulator-specific base plate connected to articulator surface of the lower plate. The mating surfaces of the upper and lower mating plates are for interconnection with a dental model plate.

The system can also generally be available as an articulator alignment kit, generally including a central alignment jig-blank, a first alignment plate for positioning on one end of the jig-blank, a second alignment plate for positioning on an opposite end of the jig-blank and an articulator-specific base plate connected to each of the first and second alignment plates, each articulator-specific base plate for connection to a respective upper and lower jaw of an articulator.

In addition, the method for aligning an articulator having an upper and lower jaw, generally includes placing an alignment jig-blank between the upper and lower jaws, connecting an upper alignment plate combination on the upper jaw of the articulator, connecting a lower alignment plate combination on the lower jaw of the articulator, placing the upper and lower alignment plate combinations in contact with the alignment jig-blank and performing adjustments on the articulator jaws thereby aligning the articulator.

Typically, the upper alignment plate combination on the upper jaw of the articulator and the lower alignment plate combination on the lower jaw of the articulator each comprise a base alignment plate connected to an articulator-specific base plate.

In addition, the method of aligning a dental articulator, can also include pre-fitting a first proprietary mounting base to a first generic mounting base, pre-fitting a second proprietary mounting base to a second generic mounting base, connecting the first proprietary mounting base to a first generic mounting base combination to an upper jaw of an articulator, connecting the second proprietary mounting base to a second generic mounting base combination to a lower jaw of an articulator, placing an articulator alignment jig-blank between jaws of an articulator, placing the two combinations in contact with the articulator jig-blank and making alignment adjustments to the articulator jaws to accommodate the articulator jig-blank for subsequent affixation of a dental model between the jaws.

As such, any dental articulator apparatus, can include a main articulator body, an upper jaw connected to the body, a lower jaw connected to the body and in opposition to the upper jaw, an upper proprietary mounting base connected to the upper jaw and an upper generic mounting base connected to the upper proprietary mounting base and a lower proprietary mounting base connected to the lower jaw and a lower generic mounting base connected to the lower articulator specific base;

As a entire system, any dental articulator system, can include a dental articulator having an upper and lower jaw, an articulator base connected to each of the upper and lower jaws, an additional articulator base connected to each of the upper and lower articulator bases, wherein the upper articulator bases and the lower articulator bases are a first upper and lower articulator base combination, an articulator alignment jig-blank for connecting between the additional articulator bases and a dental model having an upper and lower jaw, wherein each of the upper and lower jaws each include a second upper and lower articulator base combination for connection to the upper and lower jaws of the articulator, the dental model having a bite pattern of a patient.

In a typical implementation, the jig-blank is for alignment of the articulator by placement in between the first upper and lower articulator combinations. In addition, the first upper and lower base combinations are removable from the upper and lower jaws of the articulator. Furthermore, the second upper and lower articulator combinations are connectable to the upper and lower jaws of the articulator to form a bite pattern matching the bite pattern of the patient.

It is therefore appreciated that any proprietary articulator can be aligned with the non-specific articulator alignment/calibration jig as described. For any given articulator, the proprietary bases of the given articulator can be pre-fitted with generic or non-specific articulator bases. In general, it is appreciated that the pre-fitting be a permanent fitting such as by glue of other suitable means. It is understood that the pre-fitting can also be non-permanent but strong such as by magnets. Therefore, the proprietary bases are fitted to be connected to the articulator jaws as normal. However, the generic bases are now affixed to the proprietary bases in opposition to one another. Therefore, the generic calibration jig can now be placed in between the generic bases for alignment procedure. It is therefore appreciated that the generic bases can be connected to any proprietary base pairs so that the inexpensive generic calibration jig can be used in any articulator because it interfaces with the generic bases attached to the proprietary bases.

Therefore, when it comes to actual practice, when models are typically made by permanently attaching proprietary bases to the stone of the model, generic bases can be permanently attached, instead of along with metal or a magnet. Therefore, when the model dries and is complete it can be interfaced with a mating generic plate that is connected to the proprietary base. It is understood that a single generic base can be used to create an impression on the drying stone and keep the metal or magnet in place when drying. Suitable lubricant can be used so that the generic base can be removed after drying. The model then includes an impression along with metal or a magnet that can be mated with an identical generic base that is pre-fitted to the proprietary base. The generic base in the combination includes a magnet to attract to the magnet or metal in the model. As such, by simple magnetic attraction, the model can be connected and disconnected to any articulator that includes any proprietary/generic base combination by virtue of the fact that generic base impression and the necessary metal or magnet is built into the model. Therefore, by creating this generic mounting base interface, models can be used with any articulator. It is appreciated that other coupling devices other than magnets are contemplated.

Referring again to the above description of the articulator apparatuses, it is appreciated that the bases of those above-described apparatuses can be mated to the generic mounting bases as just described. Therefore, if it is desired to place one of the models created using the apparatuses into proprietary articulators, a magnet or metal can be added to the apparatus and the apparatus can mate directly with the generic base because the apparatus and the generic bases can be modeled to mate with one another.

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. An articulator apparatus, comprising:
a base having an upper surface;
a first outer row of pins arranged along a portion of the base;
a second inner row of pins arranged along another portion of the base adjacent the first outer row of pins; and
an inner platform located on the base adjacent the second inner row of pins.

2. The apparatus as claimed in claim 1 wherein individual pins of the rows of pins are perpendicular to the upper surface.

3. The apparatus as claimed in claim 1 wherein individual pins of the first outer row of pins have a height H.

4. The apparatus as claimed in claim 3 wherein individual pins of the second inner row of pins have a height h.

5. The apparatus as claimed in claim 4 wherein H is greater than h.

6. The apparatus as claimed in claim 1 wherein the inner platform is positioned above the upper surface thereby forming a perimeter wall around the platform.

7. The apparatus as claimed in claim 6 wherein the perimeter wall is adjacent the second inner row of pins

8. The apparatus as claimed in claim 6 wherein the perimeter wall comprises a series of ridges adjacent the inner row of pins.

9. The apparatus as claimed in claim 1 further comprising a half-hinge connected to a rear end of the base.

10. A dental articulator calibration system, comprising:
an elongate central body having an upper plate-receiving opening and a lower plate-receiving opening;
an upper plate having a mating surface for mating with the upper plate-receiving opening and an articulator surface;
a lower plate having a mating surface for mating with the lower plate-receiving opening and an articulator surface;
a first articulator-specific base plate connected to the upper plate; and
a second articulator-specific base plate connected to the lower plate.

11. The system as claimed in claim 10 wherein the first articulator-specific base plate is connected to the articulator surface of the upper plate and the second articulator-specific base plate connected to articulator surface of the lower plate.

12. The system as claimed in claim 10 wherein the mating surfaces of the upper and lower mating plates are for interconnection with a dental model plate.

13. A method for aligning an articulator having an upper and lower jaw, comprising:
placing an alignment jig-blank between the upper and lower jaws;
connecting an upper alignment plate combination on the upper jaw of the articulator;
connecting a lower alignment plate combination on the lower jaw of the articulator;
placing the upper and lower alignment plate combinations in contact with the alignment jig-blank; and
performing adjustments on the articulator jaws thereby aligning the articulator.
